(19) United States
(12) Patent Application Publication
(10) Pub. No.: US 2003/0101340 A1
(43) Pub. Date: May 29, 2003

(54) Interconnecting device, computer readable medium having communication setting program, and communication setting method

(76) Inventor: Takayuki Sato, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 10/063,007

(22) Filed: Mar. 12, 2002

(30) Foreign Application Priority Data
Nov. 27, 2001 (JP) 2001-360467

(51) Int. Cl. H04L 9/00

(52) U.S. Cl. 713/155

(57) ABSTRACT

An interconnecting device interconnects communication in a computer network. A receiving unit receives wirelessly a device identifier of a communication device in the computer network from a wireless communication device which holds the device identifier. A setting unit sets communication in the computer network to allow the communication device identified by the device identifier to communicate in the computer network. Thereby, the interconnecting device provides a computer network system with high security against improper and unauthorized entries.

### CROSS REFERENCE TO RELATED APPLICATIONS

This patent application claims priority from a Japanese patent application, No. 2001-360467 filed on Nov. 27, 2001, the contents of which are incorporated herein by reference.

### BACKGROUND OF INVENTION

1. Field of the Invention

The present invention relates to an interconnecting device, a communication setting program, and a communication setting method. More particularly, the present invention relates to an interconnecting device for setting communication in a computer network to allow communication thereof based on device identifier information received by the interconnecting device.

2. Description of the Related Art

Conventionally, security against improper entries by unauthorized computers into a computer network is realized using a management server, which generally manages the computer network. For example, communication in the computer network is limited to users authenticated by the management server, or by specific VLAN settings.

However, in a conventional computer network system, since access by a computer to information in the computer network, such as a data base, is limited to users that have been authenticated by the management server, a computer first connects to the management server through the computer network. In the conventional system, there is no unit or device that controls all communication of a computer in the computer network and limited communication access is allowed to any computer for purposes of authentication by the management server. Consequently, there is potentially a security problem in that an unauthorized computer may gain access to the network by breaching the security of one of the devices communicating in the network and then could easily communicate in the computer network although not being authenticated by the management server.

### SUMMARY OF INVENTION

Therefore, it is an object of the present invention to provide an interconnecting device, a communication setting program, and a communication setting method, which are capable of overcoming the above drawbacks accompanying the conventional art. The above and other objects can be achieved by combinations described in the independent claims. The dependent claims define further advantageous and exemplary combinations of the present invention.

According to the present invention, an interconnecting device that interconnects communication in a computer network includes a receiving unit that receives, via wireless communication, a device identifier of a communication device in the computer network from a wireless communication device which holds the device identifier. A setting unit sets a communication setting of the computer network to allow the communication device identified by the device identifier received by the receiving unit to communicate in the computer network.

According to the present invention, the communication setting of the computer network is maintained only if the receiving unit again receives the device identifier within a predetermined period of time.

In another aspect of the present invention, the interconnecting device includes a decoder that decodes an encrypted device identifier when the receiving unit receives the encrypted device identifier.

In still another aspect of the present invention, the setting unit sets the interconnecting device to allow the communication device, identified by the device identifier, to communicate by the interconnecting device.

In still another aspect of the present invention, the setting unit further sets a communication bandwidth of the communication device, identified by the device identifier, in said interconnecting device.

In still another aspect of the present invention, the interconnecting device includes a transmitting unit that transmits the device identifier to another interconnecting device, which is connected to the interconnecting device, so as to allow communication of the communication device, identified by the device identifier, by said another interconnecting device.

In still another aspect of the present invention, the computer network includes another computer network and the another interconnecting device interconnects the computer network and the another computer network. The transmitting unit transmits the device identifier to the another interconnecting device so as to allow communication of the communication device, identified by the device identifier, in the another computer network.

In still another aspect of the present invention, an interconnecting device includes a transmitting unit that transmits the device identifier to a management apparatus that manages settings of the computer network so as to allow communication of the communication device, identified by the device identifier, in the computer network.

In still another aspect of the present invention, an interconnecting device includes a connection port that connects the communication device to the interconnecting device. The setting unit sets the interconnecting device to allow communication of the communication device using the connection port.

In still another aspect of the present invention, the receiving unit further receives a connection port number corresponding to the device identifier of the communication device. The setting unit sets the interconnecting device to allow communication of the communication device, identified by the device identifier, using the connection port identified by the connection port number.

In still another aspect of the present invention, an interconnecting device includes a transmitting unit that transmits, to the wireless communication device, a connection port number for identifying the connection port by which communication by the communication device is allowed.

In still another aspect of the present invention, the setting unit sets a bandwidth for communication via the connection port.

According to the present invention, an interconnecting device includes a storage unit that stores the device identifier of at least one communication device which is allowed to communicate using the interconnecting device and a communication controller that limits communication by the interconnecting device to the at least one communication device having the device identifier stored in the storage unit.

In another aspect of the present invention, the setting unit stores the device identifier received by the receiving unit to allow the communication device, identified by the device identifier, to communicate using the interconnecting device.

In still another aspect of the present invention, an interconnecting device includes a plurality of connection ports that respectively connect a plurality of communication devices. The storage unit stores the device identifier of at least one communication device to correspond to at least one of the plurality of connection ports to allow communication using the one of the plurality of connection ports.

According to the present invention, the receiving unit monitors receipt of the device identifier from the wireless communication device after a predetermined time has past since the device identifier was previously received from the wireless communication device. The setting unit maintains the communication setting of the computer network to allow the communication device to communicate in the computer network if the receiving unit receives the device identifier once again.

When the receiving unit does not receive the device identifier from the wireless communication device within a predetermined period of time after the device identifier was last received from the wireless communication device, the setting unit sets the communication setting of the computer network to prohibit communication of the communication device in the computer network.

In yet another aspect of the invention, the receiving unit receives, from the wireless communication device, battery lifetime information that indicates a lifetime of a battery in the wireless communication device, the battery lifetime being less than a predetermined lifetime. When the receiving unit receives the battery lifetime information, the setting unit maintains the communication setting of the computer network for a predetermined time to allow the communication device to communicate in the computer network.

The present invention provides a computer readable medium having a communication setting program for an interconnecting device to set a communication setting in a computer network. The program includes a receiving module that enables the interconnecting device to receive, by wireless, a device identifier of a communication device in the computer network from a wireless communication device which holds the device identifier. A setting module that enables the interconnecting device to set the communication setting of the computer network to allow the communication device identified by the device identifier to communicate in the computer network.

In one aspect of the communication setting program, the setting module enables the interconnecting device to set the interconnecting device to allow the communication device, identified by the device identifier, to communicate by the interconnecting device.

In another aspect of the communication setting program, a transmitting module enables the interconnecting device to transmit the device identifier to another interconnecting device, to set the another interconnecting device, so as to allow communication of the communication device identified by the device identifier by the another interconnecting device. The another interconnecting device being connected to the interconnecting device.

The present invention provides a method of setting communication of a computer network by an interconnecting device that interconnects communication in the computer network. The method includes receiving wirelessly a device identifier of a communication device in the computer network from a wireless communication device which holds the device identifier; and setting communication of the computer network to allow the communication device identified by the device identifier to communicate in the computer network.

This summary of the present invention does not necessarily describe all necessary features so that the invention may also be a sub-combination of these described features.

### BRIEF DESCRIPTION OF DRAWINGS

FIG. 1 shows one example of a configuration of a computer network 100 according to one embodiment of the present invention.

FIG. 2 shows a structure of an interconnecting device 10a of the present embodiment.

FIG. 3 shows one example of a data format of a communication control file stored in a storage unit 110.

FIG. 4 shows one example of a flowchart of a communication setting method according to one embodiment of the present invention.

FIG. 5 shows one example of a sequence of a setting information update method of a wireless communication device 40a according to one embodiment of the present invention.

FIG. 6 shows one example of a configuration of the computer network 100 and a computer network 200 according to one embodiment of the present invention.

FIG. 7 shows one example of hardware components in a management apparatus 20 according to one embodiment of the present invention.

### DETAILED DESCRIPTION

The invention will now be described based on preferred embodiments, which do not intend to limit the scope of the present invention, but rather to exemplify the invention. All of the features and the combinations thereof described in the embodiments are not necessarily essential to the invention.

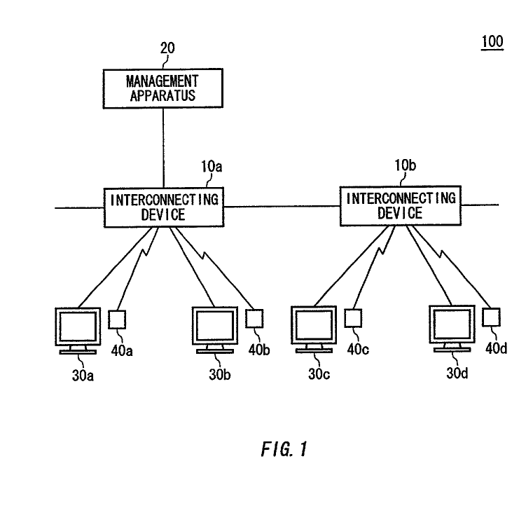

FIG. 1 shows computer network 100 according to one embodiment of the present invention. Computer network 100 of the present embodiment has interconnecting devices 10a and 10b, such as a switching hub to interconnect communication in computer network 100; management apparatus 20 to manage communication in computer network 100; communication devices 30a, 30b, 30c, and 30d which communicate in computer network 100; and wireless communication devices 40a, 40b, 40c, and 40d to perform wireless communication with interconnecting device 10a or 10b. Communication of interconnecting device 10a or 10b with wireless communication devices 40a, 40b, 40c, and 40d is preferably short distance wireless communication such as Bluetooth (TM) or infrared radiation data communication such as IrDA. Communication of interconnecting device 10a with communication devices 30a and 30b as well as communication of interconnecting device 10b with communication devices 30c and 30d may be wire communication or wireless communication.

Interconnecting devices 10a and 10b receive setting information of computer network 100 from wireless communication device 40a, 40b, 40c, or 40d and set a communication setting of computer network 100. For example, interconnecting device 10a receives a MAC address as a device identifier of communication device 30a by wireless communication with wireless communication device 40a. Then interconnecting device 10a sets a communication setting to allow communication of interconnecting device 10a with communication device 30a identified by the received MAC address.

A user of communication device 30a has wireless communication device 40a in which the MAC address of communication device 30a is stored as an ID to connect communication device 30a to computer network 100. Interconnecting device 10a allows communication of communication device 30a in interconnecting device 10a by receiving the MAC address of communication device 30a from wireless communication device 40a in a case where the user comes close to interconnecting device 10a in order to use communication device 30a. So the user can enter computer network 100 using communication device 30a. Interconnecting device 10a prohibits communication of interconnecting device 10a with communication device 30a in a case where the user goes away from interconnecting device 10a and interconnecting device 10a can not receive the MAC address of communication device 30a.

Interconnecting device 10a transmits the MAC address received from wireless communication device 40a to interconnecting device 10b to allow communication, using interconnecting device 10b, of communication device 30a identified by the MAC address received from wireless communication device 40a. Then interconnecting device 10b sets interconnecting device 10b to allow communication, using interconnecting device 10b, of communication device 30a identified by the MAC address received from interconnecting device 10a. A user of communication device 30a has wireless communication device 40a which stores the MAC address of communication device 30a. The user can communicate with communication devices 30c and 30d connected to interconnecting device 10b by using communication device 30a and coming close to interconnecting device 10a to use communication device 30a.

In another example, interconnecting device 10a transmits the MAC address received from wireless communication device 40a to management apparatus 20 to allow communication of communication device 30a, identified by the MAC address received from wireless communication device 40a, in computer network 100. Then management device 20 sets interconnecting devices 10a and 10b to allow communication of communication device 30a identified by the MAC address received from interconnecting device 10a. A user of communication device 30a has wireless communication device 40a which stores the MAC address of communication device 30a. The user can then communicate in computer network 100 by using communication device 30a since the user comes close to interconnecting device 10a to use communication device 30a.

Wireless communication device 40a may transmit battery lifetime information that indicates the remaining lifetime of the battery in wireless communication device 40a, which is less than a predetermined lifetime, to interconnecting device 10a. In this case, interconnecting device 10a maintains settings of interconnecting devices 10a and 10b to allow communication of communication device 30a in computer network 100. Wireless communication device 40a may transmit battery lifetime information of wireless communication device 40a, which indicates that the remaining lifetime of the battery is less than the predetermined lifetime, to communication device 30a through interconnecting device 10a. In this case, communication device 30a notifies the user by displaying information, on a monitor, to indicate battery lifetime of wireless communication device 40a, which is less than the predetermined lifetime. In this case, communication device 30a transmits an authentication information request signal to management apparatus 20. In a case where authentication information input by the user is authenticated, management apparatus 20 maintains settings of interconnecting devices 10a and 10b to allow communication of communication device 30a in computer network 100.

Management apparatus 20 may communicate with wireless communication device 40a, 40b, 40c, or 40d, through interconnecting device 10a or 10b, and update setting information, such as device identifier of the communication device stored in wireless communication device 40a, 40b, 40c, or 40d. Interconnecting devices 10a and 10b may transmit information to indicate completion of setting in a case of setting interconnecting device 10a or 10b to allow communication in interconnecting device 10a or 10b of communication device 30a, 30b, 30c, or 30d identified by the MAC address received from wireless communication device 40a, 40b, 40c, or 40d. And then wireless communication devices 40a, 40b, 40c, and 40d may notify completion of settings of interconnecting device 10a or 10b by display, sound or the like in a case where information to indicate completion of setting is received from interconnecting device 10a or 10b.

According to interconnecting devices 10a and 10b of the present embodiment, it is possible to allow only a predetermined user to enter into computer network 100 by using a predetermined communication device. The predetermined user has a predetermined wireless communication device, which is required in order for the predetermined communication device used by the predetermined user to enter computer network 100. Therefore, since access to computer network 100 is allowed to only the predetermined user who has the predetermined communication device and the predetermined wireless communication device, it is possible to prevent improper entries into computer network 100.

And according to computer network 100 of the present embodiment, since entries of communication devices 30a to 30d into computer network 100 are limited by interconnecting devices 10a and 10b, a communication device which is not allowed to communicate in interconnecting devices 10a and 10b can be prohibited from connecting to management apparatus 20. So, by using computer network 100 of the present embodiment, a computer system with high security against improper entries can be realized.

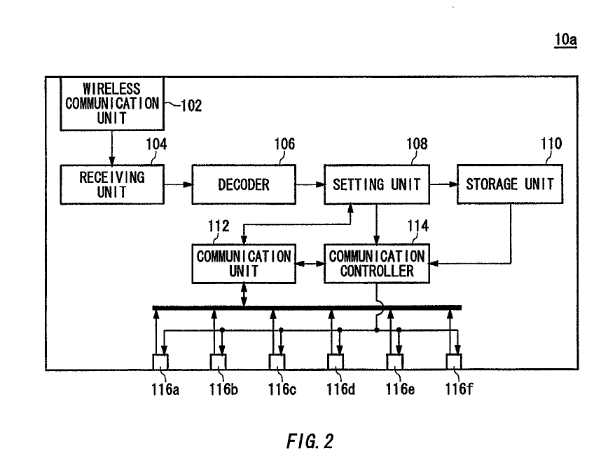

FIG. 2 shows a structure of interconnecting device 10a in the present embodiment. Interconnecting device 10a includes wireless communication unit 102, receiving unit 104, decoder 106, setting unit 108, storage unit 110, communication unit 112, communication controller 114, and connection ports 116a to 116f to which a communication device is connected. Wireless communication unit 102 receives a wireless signal from wireless communication device 40a. Receiving unit 104 receives device identifier of a communication device based on the signal received by wireless communication unit 102. Decoder 106 decodes an encrypted device identifier. Setting unit 108 sets communication setting of computer network 100 to allow communication, in computer network 100, of the communication device identified by the received device identifier. Storage unit 110 stores the device identifier of at least one communication device for which communication is allowed in interconnecting device 10a. Communication unit 112 transfers or receives data to/from interconnecting device 10b, management apparatus 20, and communication devices 30a and 30b.

Wireless communication unit 102 receives the signal from wireless communication device 40a, in which device identifier of communication device 30a is stored, by using wireless communication. Then receiving unit 104 receives the device identifier of the communication device for which communication is allowed in computer network 100 based on the signal received by wireless communication unit 102. Decoder 106 decodes an encrypted device identifier in a case where the device identifier received by receiving unit 104 is encrypted. Decoder 106 outputs the decoded device identifier to setting unit 108.

Setting unit 108 sets communication setting of computer network 100 to allow communication, in computer network 100, of the communication device identified by the received device identifier, received by receiving unit 104. To do this, at first, setting unit 108 sets communication setting of interconnecting device 10a to allow communication, in interconnecting device 10a, of the communication device identified by the received device identifier received by receiving unit 104. Concretely, setting unit 108 enables the communication device, identified by the device identifier received by receiving unit 104, to communicate using interconnecting device 10a by storing the device identifier received by receiving unit 104 into storage unit 110.

Next, communication controller 114 limits the communication device, which is allowed to communicate in interconnecting device 10a, based on the device identifier stored into storage unit 110. That is, communication controller 114 allows communication using interconnecting device 10a for the communication device identified by the device identifier received by receiving unit 104 and stored into storage unit 110. For example, when communication controller 114 refers to header information of data received by communication unit 112, and the device identifier of the associated communication device, which is included in the address source in the header information, is equal to the device identifier stored in storage unit 110, communication controller 114 allows communication unit 112 to transmit data.

Communication unit 112 receives the device identifier of the communication device from interconnecting device 10b to allow communication in interconnecting device 10a. Then setting unit 108 enables the communication device identified by device identifier received by communication unit 112 to communicate in interconnecting device 10a by storing the device identifier received by communication unit 112 into storage unit 110.

Communication unit 112 may transmit device identifier received by receiving unit 104 to interconnecting device 10b to allow the communication device identified by the device identifier received by receiving unit 104 to communicate in interconnecting device 10b, which is connected to interconnecting device 10a. Communication unit 112 may transmit device identifier received by receiving unit 104 to management apparatus 20 managing computer network 100 to make the management apparatus allow the communication device identified by the device identifier received by receiving unit 104 to communicate in computer network 100.

Setting unit 108 may set bandwidth of communication, in interconnecting device 10a, for the communication device identified by a device identifier received by receiving unit 104. For example, setting unit 108 may set a priority order for each of a plurality of connection ports 116a to 116f. Further, setting unit 108 may set upper limitation of bandwidth for each of connection ports 116a to 116f.

Setting unit 108 may set communication setting of interconnecting device 10a to allow the communication device, identified by the device identifier received by receiving unit 104, to communicate, using a predetermined connection port of the plurality of connection ports 116a to 116f of interconnecting device 10a. In this case, wireless communication unit 102 transmits the connection port number, that identifies the connection port for which communication by the communication device is allowed, to wireless communication device 40a. Wireless communication device 40a notifies a user of a connection port number received from interconnecting device 10a by displaying the connection port number on a monitor. Communication device 30a is connected to the connection port identified by the connection port number notified by wireless communication device 40a, and the user can enter computer network 100 by using communication device 30a.

Wireless communication unit 102 may receive by wireless communication a signal from wireless communication device 40a in which device identifier and the connection port number of the communication device are stored. Receiving unit 104 may further receive the connection port number corresponding to the device identifier of the communication device based on a signal received by wireless communication unit 102. Communication controller 114 may limit communication in interconnecting device 10a of the communication device connected to either of connection ports 116a to 116f based on the device identifier and connection port number received by receiving unit 104.

For example, receiving unit 104 receives device identifier of communication device 30a for which communication is allowed in computer network 100 and the connection port number of connection port 116a based on a signal received by wireless communication unit 102. Receiving unit 104 receives device identifier of communication device 30b for which communication is allowed in computer network 100 and the connection port number of connection port 116b.

Next, setting unit 108 stores a device identifier into storage unit 110 to allow communication device 30a to communicate in connection port 116a. Communication device 30a is identified by the device identifier received from wireless communication device 40a. Setting unit 108 stores a device identifier into storage unit 110 to allow communication device 30b to communicate in connection port 116b. Communication device 30b is identified by the corresponding device identifier received from wireless communication device 40b. Communication controller 114 limits the communication device that is allowed communication based on the device identifier(s) stored in storage unit 110.

Further, communication controller 114 may limit communication in interconnecting device 10a of communication device 30c or 30d connected to interconnecting device 10b based on the device identifier received from wireless communication device 40c or 40d in interconnecting device 10b. Setting unit 108 may set bandwidth of communication using connection ports 116a to 116f.

Receiving unit 104 preferably receives repeatedly a device identifier of communication device 30a from a signal repeated by wireless communication unit 102 at a predetermined time interval. Concretely, receiving unit 104 attempts again to receive, i.e., interrogates or awaits, the device identifier of communication device 30a from wireless communication device 40a when a predetermined time has past since the device identifier of communication device 30a was last received from wireless communication device 40a. If receiving unit 104 receives the device identifier of communication device 30a again, setting unit 108 maintains communication setting of interconnecting device 10a to allow communication device 30a to communicate in computer network 100. When receiving unit 104 does not receive the device identifier of communication device 30a, setting unit 108 sets communication setting of interconnecting device 10a to prohibit communication of communication device 30a in computer network 100.

Receiving unit 104 may receive information from wireless communication device 40a that indicates the remaining lifetime of a battery in wireless communication device 40a is less than a predetermined lifetime. When receiving unit 104 receives information to indicate the remaining lifetime of the battery, setting unit 108 may maintain communication setting of interconnecting device 10a for a predetermined time to allow communication device 30a to communicate in interconnecting device 10a. Communication unit 112 may transmit information to indicate the remaining lifetime of the battery, received by receiving unit 104, to management apparatus 20 or communication device 30a.

According to interconnecting device 10a of the present embodiment, since an encrypted device identifier of the communication device is received and decoded, disclosure of a device identifier stored into wireless communication device 40a can be prevented. Moreover, advantageously the encrypted device identifier serves as a secure means of identifying a communication device to interconnecting device 10a. And, according to interconnecting device 10a of the present embodiment, since bandwidth in interconnecting device 10a for each communication device or for each connection port can be set, a communication path in computer network 100 can efficiently be used. And, according to computer network 100 of the present embodiment, since each interconnecting device limits a communication device that is allowed to communicate using the interconnecting device, a computer network system with high security against improper entries can be realized.

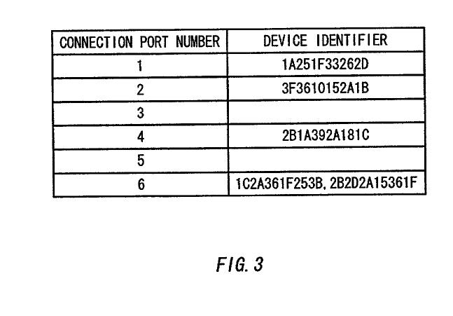

FIG. 3 shows one example of a data format of a communication control file stored into storage unit 110 of the present embodiment. The communication control file has a connection port number field and a device identifier field. The connection port number field stores the connection port number assigned to identify each of a plurality of connection ports in the interconnecting device. The device identifier field stores a device identifier to identify a communication device associated with one or more corresponding connection port. For example, the device identifier field stores the MAC address of a communication device.

In the present embodiment, the connection port number of connection port 116a is 1, the connection port number of connection port 116b is 2, the connection port number of connection port 116c is 3, the connection port number of connection port 116d is 4, the connection port number of connection port 116e is 5, and the connection port number of connection port 116f is 6.

The communication control file stores a device identifier of at least one communication device to correspond to at least one of the plurality of connection ports 116a to 116f to allow communication using the one of the plurality of connection ports. Communication controller 114 refers to header information of data received from a predetermined connection port. When the device identifier of the associated communication device, which is included in the header information as the transmission source information, is already stored in the communication control file to correspond to the predetermined connection port, communication controller 114 allows communication unit 112 to transmit the data.

Communication controller 114 allows the communication device identified by device identifier 1A251F33262D to communicate through connection port 116a (connection port 1). Communication controller 114 allows the communication device identified by device identifier 3F3610152A1B to communicate through connection port 116b. Communication controller 114 allows the communication device identified by device identifier 2B1A392A181C to communicate through connection port 116d.

Communication controller 114 allows communication in connection port 116f, which is connection port number 6, of the communication device identified by device identifier 1C2A361F253B and the communication device identified by 2B2D2A15361F. This is a case where the communication device identified by the device identifier 1C2A361F253B and the communication device identified by the device identifier 2B2D2A15361F are connected to the connection ports of interconnecting device 10b which is connected to connection port 116f.

According to interconnecting device 10a of the present embodiment, it is possible to allow predetermined communication devices to communicate through corresponding predetermined connection ports by limiting the communication device that is allowed communication in each of the plurality of connection ports. Thereby, a computer network with high security against improper entries can be realized.

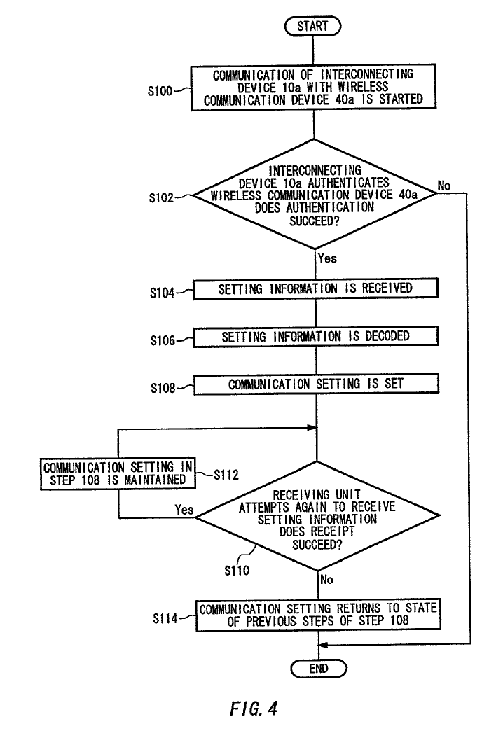

FIG. 4 shows one example of a flowchart of a communication setting method according to the present embodiment. Management apparatus 20 stores a device identifier of communication device 30a, and setting information of the connection port number and any other necessary or desirable setting information based on the instruction of an administrator. The administrator hands wireless communication device 40a to the user of communication device 30a and the user keeps wireless communication device 40a.

When the user approaches interconnecting device 10a, interconnecting device 10a starts to communicate with wireless communication device 40a (S100). Next, interconnecting device 10a authenticates wireless communication device 40a (S102). When authentication fails in S102, the communication setting of interconnecting device 10a is not performed and a flow of the communication setting method in the present embodiment terminates. When authentication succeeds in S102, wireless communication unit 102 receives a wireless signal from wireless communication device 40a and receiving unit 104 receives encrypted setting information transmitted from wireless communication device 40a (S104). Next, decoder 106 decodes the encrypted setting information (S106). Next, setting unit 108 sets a communication setting of interconnecting device 10a based on the setting information received by receiving unit 104 (S108). Then interconnecting device 10a starts communication based on the communication setting set by setting unit 108 in S108.

Receiving unit 104 attempts again, by interrogation and/or waiting, to receive the setting information from wireless communication device 40a when a predetermined time has past since setting information was last received in S108 (S110). When receiving unit 104 receives the setting information in S110, communication setting in S108 is maintained (S112), and the sequence returns to S110. When receiving unit 104 does not receive setting information in S110, setting unit 108 changes the state of communication setting of interconnecting device 10a to a state before S108 (S114) and the flow of the communication setting method according to the present embodiment terminates.

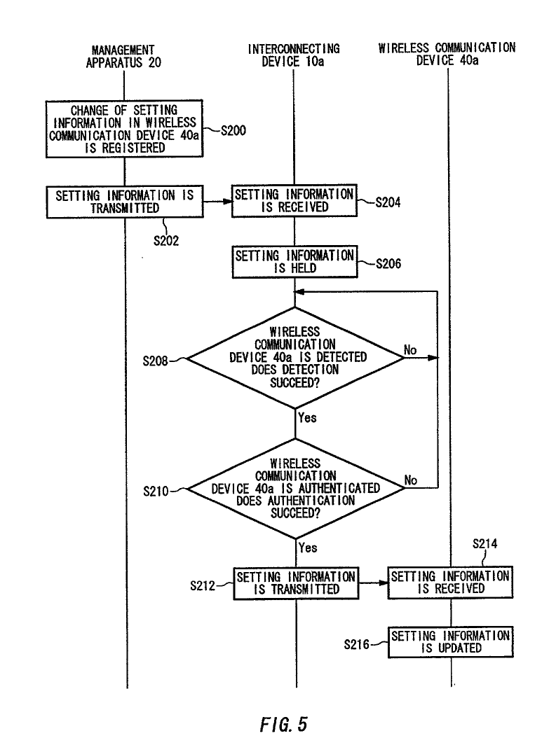

FIG. 5 shows one example of a sequence of a setting information update method of wireless communication device 40a according to the present embodiment. The administrator enters changes of setting information to be stored in wireless communication device 40a (S200). Management apparatus 20 transmits the setting information changed by the administrator to interconnecting device 10a (S202).

Next, interconnecting device 10a receives setting information transmitted from management apparatus 20 (S204). Then interconnecting device 10a temporarily stores the setting information received from management apparatus 20 (S206). Next, interconnecting device 10a detects wireless communication device 40a (S208). When interconnecting device 10a can not detect wireless communication device 40a in S208, interconnecting device 10a holds the setting information received from management apparatus 20 and attempts again to detect wireless communication device 40a. When interconnecting device 10a detects wireless communication device 40a in S208, interconnecting device 10a authenticates wireless communication device 40a (S210). When authentication of wireless communication device 40a fails in S210, the sequence returns to S208 and interconnecting device 10a again detects wireless communication device 40a. When authentication succeeds in S210, interconnecting device 10a transmits the setting information received from management apparatus 20 (S212).

Next, wireless communication device 40a receives setting information transmitted from interconnecting device 10a (S214). Next, wireless communication device 40a updates the setting information already stored in wireless communication device 40a to setting information last received from interconnecting device 10a (S216). According to the setting information update method of wireless communication device 40a in the present embodiment, the administrator can change setting information of wireless communication device 40a without collecting the wireless communication device 40a from the user.

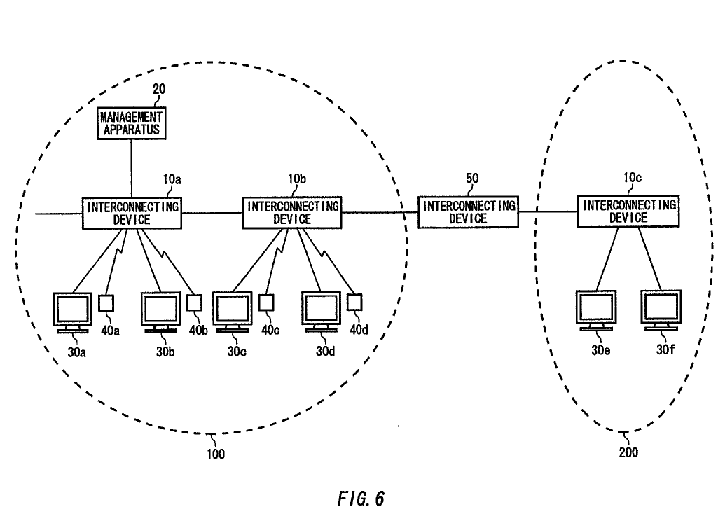

FIG. 6 shows one example of a configuration of computer network 100 and computer network 200 according to the present embodiment. Computer network 100 has the same configuration shown in FIG. 1. Computer network 200 includes interconnecting device 10c, such as a switching hub, to interconnect communication in computer network 200, and communication devices 30e and 30f which communicate in computer network 200. Segments of computer network 100 and computer network 200 are different, and computer network 100 and computer network 200 are connected via interconnecting device 50, such as a bridge or a router.

The user of the communication device 30a has wireless communication device 40a and comes close to interconnecting device 10a to use communication device 30a. Interconnecting device 10a transmits the device identifier of communication device 30a, received from wireless communication device 40a, to interconnecting device 50, via interconnecting device 10b, to allow communication device 30a to communicate in computer network 200. Then interconnecting device 50 allows communication device 30a, which is identified by the device identifier received from interconnecting device 10a, to communicate by interconnecting device 50. Therefore, communication device 30a can communicate with communication devices 30e and 30f in computer network 200 whose segment is different.

According to interconnecting device 10a of the present embodiment, the user of a communication device can enter a computer network, having a segment that is different from the segment to which the communication device belongs, by coming close to the interconnecting device connected to the communication device.

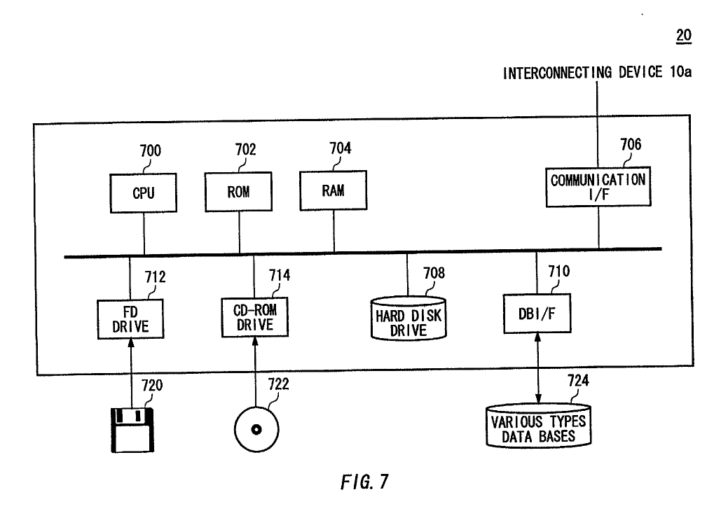

FIG. 7 shows one example of hardware components of management apparatus 20 according to the present embodiment. Management apparatus 20 includes CPU 700, ROM 702, RAM 704, communication interface 706, hard disk drive 708, data base interface 710, floppy disk drive 712 and CD-ROM drive 714, and controls each of the aforementioned components. CPU 700 operates based on a program stored in ROM 702 and RAM 704. Communication interface 706 communicates with interconnecting device 10a via a computer network. Data base interface 710 writes data into a data base and updates contents of the data base.

Floppy disk drive 712 reads data or the program from floppy disk 720 and transmits the data or the program to communication interface 706. CD-ROM drive 714 reads out data or a program from CD-ROM 722 and transmits the data or the program to communication interface 706. Communication interface 706 transmits the data or the program from floppy disk drive 712 or CD-ROM drive 714 to interconnecting device 10a. Data base interface 710 connects to various types of data bases 724 to communicate data.

The program supplied to interconnecting device 10a may be stored into a recording medium, such as floppy disk 720 or CD-ROM 722, and provided to a user. The program stored in the recording medium may be compressed or decompressed. The program is read from the recording medium and the program is installed into interconnecting device 10a to be executed by interconnecting device 10a.

The program stored in the recording medium and provided to the user, that is, the program installed into interconnecting device 10a has a wireless communication module, a receiving module, a setting module, a decoder module, a transmit module, a storage module, and a communication control module as a functional configuration. Explanation is omitted here since each module accesses interconnecting device 10a and a process performed by CPU 700 is identified as a function and an operation of corresponding members in interconnecting device 10a which are described in connection with FIGS. 1 to 6.

Functions of one or all of the operations of interconnecting device 10a in all the embodiments in the present invention can be stored in floppy disk 720 or CD-ROM 722 as one example of the recording medium shown in FIG. 7.

These programs may directly be read from the recording medium and be executed by interconnecting device 10a or may be executed after the programs are installed into interconnecting device 10a. Further, the programs may be stored into a single recording medium or a plurality of recording media. Furthermore, the programs may be stored in an encoded form.

It is possible to use an optical recording medium of a DVD or a MD, an optical magnetic recording medium of a PD, a tape medium, a magnetic recording medium, a semiconductor memory such as an IC card or a miniature card, besides the floppy disk or the CD-ROM as the recording medium. The hard disk or the storage device of the RAM in a server system connected to a dedicated communication network or the Internet may be used as the recording medium and a program may be provided to interconnecting device 10a via a communication network.

Communication devices 30a, 30b, 30c, 30d, 30e, and 30f of the present embodiment may a set of terminals in a convenience store, for example, or personal computers in an Internet coffee shop. In view of the public nature of the locations, it is necessary to have high security for the terminals in the convenience store or the personal computers in the Internet coffee shop because unspecified users have access to such computers and could use them to gain unauthorized access to computer networks. Therefore, it is possible to prevent users from improperly using a terminal in the convenience store or a personal computer in the Internet coffee shop by having wireless communication devices 40a, 40b, 40c, or 40d, which are controlled by personnel of the convenience store or the Internet coffee shop, for using the kiosk terminals in the convenience store or the personal computers in the Internet coffee shop.

Advantageously, the present invention also provides the benefit of portability for secure access to computer networks. In this, a user away from their usual communication device for accessing a computer network may still access the network with the present system by using an interconnecting device near their present location and a wireless connection thereto for the communication device. Specifically, by carrying a wireless communication device 40a, 40b, 40c, or 40d having a device identifier stored therein and establishing a wireless connection for a communication device 30a, 30b, 30c, 30d, 30e, or 30f with an interconnecting device 10a, 10b, or 10c, which is proximate to the location, the user can securely access computer network 100 or 200 as though at their usual location.

According to the present invention as aforementioned, it is possible to provide an interconnecting device capable of realizing a computer network with high security for improper entries.

Although the present invention has been described by way of exemplary embodiments, it should be understood that many changes and substitutions may be made by those skilled in the art without departing from the spirit and the scope of the present invention which is defined only by the appended claims.

1. An interconnecting device that interconnects communication in a computer network, comprising:
a receiving unit that receives, via wireless communication, a device identifier of a communication device in said computer network from a wireless communication device which holds said device identifier;
a setting unit that sets a communication setting of said computer network to allow said communication device identified by said device identifier received by said receiving unit to communicate in said computer network.

2. An interconnecting device as claimed in claim 1, wherein
said communication setting of said computer network is maintained only if said receiving unit again receives said device identifier within a predetermined period of time.

3. An interconnecting device as claimed in claim 1, further comprising
a decoder that decodes an encrypted device identifier when said receiving unit receives said encrypted device identifier.

4. An interconnecting device as claimed in claim 1, wherein
said setting unit sets said interconnecting device to allow said communication device, identified by said device identifier, to communicate by said interconnecting device.

5. An interconnecting device as claimed in claim 4, wherein
said setting unit further sets a communication bandwidth of said communication device, identified by said device identifier, in said interconnecting device.

6. An interconnecting device as claimed in claim 4, further comprising
a transmitting unit that transmits said device identifier to another interconnecting device, which is connected to said interconnecting device, so as to allow communication of said communication device, identified by said device identifier, by said another interconnecting device.

7. An interconnecting device as claimed in claim 6, wherein
said another interconnecting device interconnects said computer network and another computer network; and
said transmitting unit transmits said device identifier to said another interconnecting device so as to allow communication of said communication device, identified by said device identifier, in said another computer network.

8. An interconnecting device as claimed in claim 4, further comprising
a transmitting unit that transmits said device identifier to a management apparatus that manages settings of said computer network so as to allow communication of said communication device, identified by said device identifier, in said computer network.

9. An interconnecting device as claimed in claim 4, further comprising a connection port that connects said communication device to said interconnecting device, wherein
said setting unit sets said interconnecting device to allow communication of said communication device using said connection port.

10. An interconnecting device as claimed in claim 9, wherein
said receiving unit further receives a connection port number corresponding to said device identifier of said communication device; and
said setting unit sets said interconnecting device to allow communication of said communication device, identified by said device identifier, using said connection port identified by said connection port number.

11. An interconnecting device as claimed in claim 9, further comprising
a transmitting unit that transmits, to said wireless communication device, a connection port number for identifying said connection port by which communication by said communication device is allowed.

12. An interconnecting device as claimed in claim 9, wherein
said setting unit further sets a bandwidth for communication via said connection port.

13. An interconnecting device as claimed in claim 1, further comprising
a storage unit that stores said device identifier of at least one communication device which is allowed to communicate using said interconnecting device; and
a communication controller that limits communication by said interconnecting device to said at least one communication device having said device identifier stored in said storage unit.

14. An interconnecting device as claimed in claim 13, wherein
said setting unit stores said device identifier received by said receiving unit to allow said communication device, identified by said device identifier, to communicate using said interconnecting device.

15. An interconnecting device as claimed in claim 13, further comprising
a plurality of connection ports that respectively connect a plurality of communication devices, wherein
said storage unit stores said device identifier of said at least one communication device to correspond to at least one of said plurality of connection ports to allow communication using said one of said plurality of connection ports.

16. An interconnecting device as claimed in claim 1, wherein
said receiving unit monitors receipt of said device identifier from said wireless communication device after a predetermined time has past since said device identifier was previously received from said wireless communication device, and said setting unit maintains said communication setting of said computer network to allow said communication device to communicate in said computer network if said receiving unit receives said device identifier again.

17. An interconnecting device as claimed in claim 1, wherein
unless said receiving unit receives said device identifier from said wireless communication device within a predetermined period of time after said device identifier was last received from said wireless communication device, said setting unit sets said communication setting of said computer network to prohibit communication of said communication device in said computer network.

18. An interconnecting device as claimed in claim 1, wherein
said receiving unit receives, from said wireless communication device, battery lifetime information that indicates a lifetime of a battery in said wireless communication device, said battery lifetime being less than a predetermined lifetime, and
when said receiving unit receives said battery lifetime information, said setting unit maintains said communication setting of said computer network for a predetermined time to allow said communication device to communicate in said computer network.

19. A computer readable medium having a communication setting program for an interconnecting device to set a communication setting in a computer network, the program comprising:
a receiving module that makes said interconnecting device receive, by wireless, a device identifier of a communication device in said computer network from a wireless communication device which holds said device identifier; and
a setting module that makes said interconnecting device set said communication setting of said computer network to allow said communication device identified by said device identifier to communicate in said computer network.

20. A computer readable medium having a communication setting program as claimed in claim 19, wherein
said setting module makes said interconnecting device set said interconnecting device to allow said communication device, identified by said device identifier, to communicate by said interconnecting device.

21. A computer readable medium having a communication setting program as claimed in claim 20, further comprising
a transmitting module that makes said interconnecting device transmit said device identifier to another interconnecting device, to set said another interconnecting device, so as to allow communication of said communication device identified by said device identifier by said another interconnecting device, said another interconnecting device being connected to said interconnecting device.

22. A method of setting communication of a computer network by an interconnecting device that interconnects communication in said computer network, the method comprising:
receiving wirelessly a device identifier of a communication device in said computer network from a wireless communication device which holds said device identifier; and
setting communication of said computer network to allow said communication device identified by said device identifier to communicate in said computer network.
